(19) United States
(12) Patent Application Publication
(10) Pub. No.: US 2013/0228424 A1
(43) Pub. Date: Sep. 5, 2013

(54) ROCKER SWITCH UNIT

(71) Applicant: SCHAFFNER EMV AG, Luterbach (CH)

(72) Inventor: Fabian BECK, Ruttenen (CH)

(73) Assignee: Schaffner EMV AG, Luterbach (CH)

(21) Appl. No.: 13/862,086

(22) Filed: Apr. 12, 2013

Related U.S. Application Data
(63) Continuation of application No. PCT/EP2010/065304, filed on Oct. 13, 2010.

(51) Int. Cl. H01H 23/10

(52) U.S. Cl. CPC H01H 23/10
USPC 200/3

(57) ABSTRACT

A removable rocker switch unit (1) has a housing (7) and an ON- and an OFF-position removably fixed to the first end of the housing (2). The rocker switch (3) has two pairs of vertically and horizontally aligned connector elements (4). The housing (7) provides two chambers, each chamber for each phase of the rocker switch (7) including a first and a second connecting elements (5, 8) in each chamber arranged to be connected by a fuse (9), a current limiter (9) or both in a series connection and/or by a varistor (9) between connecting elements (5, 8) of the two different phases.

### RELATED APPLICATION

This application is a continuation of PCT/EP2010/065304, the content of which are hereby incorporated by reference.

### FIELD OF THE INVENTION

The present invention concerns a rocker switch unit that can be used in any apparatus, in a network filter, as IEC entry plug or or any other power entry module.

### DESCRIPTION OF RELATED ART

Switches or rocker switches are known prevalent in the prior art. Examples of such embodiments are given.

FR2499761 discloses a bipolar switch provided with a fuse which comprises a modular dimensions body presenting two housings for the bipolar switch and a housing including a fuse holder which can have different dimensions. Two contacts face two terminals used for connection to a neutral feeder line wire. Second feeder wire (phase wire) is connected to the terminal and to the terminal of the fuse holder.

FR2431762 discloses a circuit breaker with selecting prong presenting a cavity used for housing a fuse cartridge. This circuit breaker is intended to be placed on phase conductors of single-phase installations.

EP0690527 discloses a connector for a single phase cable which is used with a power supply network and has a plastic housing with removable covers. The top side of the housing has flat conductors that engage projecting finger contacts, with forked ends that can latch onto conductors. Within base are screw terminals that receive the cables. A fuse is used to link cable ends to the conductors. A removable cover is provided on one side of the housing allowing an easy access to the HRC fuse.

U.S. Pat. No. 3,800,259 discloses a housing which has a pair of spaced first and second contact members for respectively being interconnected in a desired electric circuit whereby the electrical circuit will not be completed unless the contact members are electrically interconnected together. A manually movable fuse member is carried by the housing and has one operating position relative to the housing where the fuse member makes electrical contact between the contact members and through the fuse part thereof so that the circuit will not only be completed by the fuse member, but also the circuit will be fused by the fused member. The fuse member, when moved to another operating position thereof relative to the housing, will break electrical contact between the contact members to open the circuit, whereby the fuse member also acts as a manually operable switch for the electrical circuit.

U.S. Pat. No. 6,734,580 relates to a fused switch unit with a housing and switching rocker, which is mounted in the housing of the fused switch unit such that it can pivot to and fro between a switched-on position and a switched-off position. The fused switch unit has apparatuses for a monitoring circuit and an indication for monitoring the serviceability of a fuse link, with the indication being arranged in the switching rocker. The indication is preferably an optical indication.

FR2191234 discloses a switch with a body, in which a fuse is inserted. The body has to be removed in order to change the body. DE9403879U discloses a similar embodiment.

U.S. Pat. No. 4,298,854 discloses a combined cartridge fuse holder and switch employs a novel switching mechanism including a pair of spaced bars arranged in a first plane and positioned adjacent an inclined ramp. A contact pin is mounted in a switch arm, which in turn is pivotally mounted so that the pin can be moved from an OFF position in which the pin rests on the inclined ramp to an ON position resting on and bridging the contact bars. One of the contact bars is electrically coupled to a first terminal while the other of the contact bars is electrically coupled through a fuse to a second terminal.

GB1170936 and GB1139696 also describe switches including removable fuses.

The disadvantage of these switches is that too many mechanical parts are involved. Too many mechanical parts lead not only to higher production costs per part, but increase the danger of failure of each of these parts. Additionally, especially where the fuse is inside the switch the fuse can not easily be replaced. Another drawback of these switching units comes from the fact that many of them can not be removed as an entire unit, but are connected to the apparatus. In case of failure of the switching unit it is not easy to be removed in order to repair the switch. Another drawback comes from the fact the switches are too big and space consuming.

### BRIEF SUMMARY OF THE INVENTION

The present invention aims to produce a rocker switching unit which avoids the drawbacks of the prior art.

Another aim is the production of a switching unit with less mechanical parts than known in the prior art and with a switch body which is simpler than the embodiments known in the prior art.

It is another aim to produce a switching unit which can easily be removed from any apparatus to change the electronic components (fuse, etc.) or the entire unit.

It is another aim to produce a switching unit which less space consuming than the models known from the prior art.

According to the invention, these aims are achieved by means of a rocker switch unit according to the independent claim. Advantageous embodiments are given in the dependent claims.

The advantages of the inventive switching unit comes from the fact that from the housing surrounding the rocker switch such that the rocker switch gives essentially the size of the housing and the entire unit. From the outer side during normal operation the fuses can not be seen. The user does not have to care these fuses. However, the unit can be pulled of from an apparatus easily to change the fuse or even the entire unit, if necessary. This can be described in a manual of the apparatus. The rocker switch unit as discloses herein can be used in any apparatus, in a network filter or as IEC entry plug.

### BRIEF DESCRIPTION OF THE DRAWINGS

The invention will be better understood with the aid of the description of an embodiment given by way of example and illustrated by the figures, in which:

FIG. 1 illustrates a general view from two sides of the rocker switch unit with an IEC inlet filter according to the invention;

FIG. 2 illustrates a rocker switch;

FIG. 3 illustrates a housing of the inventive rocker switch unit;

FIG. 4a, b illustrate in detail first connection elements;

FIG. 5a, b illustrate in detail second connection elements;

FIG. 6a, b illustrates a current limiter and a varistor to be used in the present rocker switch unit; and

FIG. 7 illustrates a back side view of the inventive rocker switch unit;

### DETAILED DESCRIPTION OF POSSIBLE EMBODIMENTS OF THE INVENTION

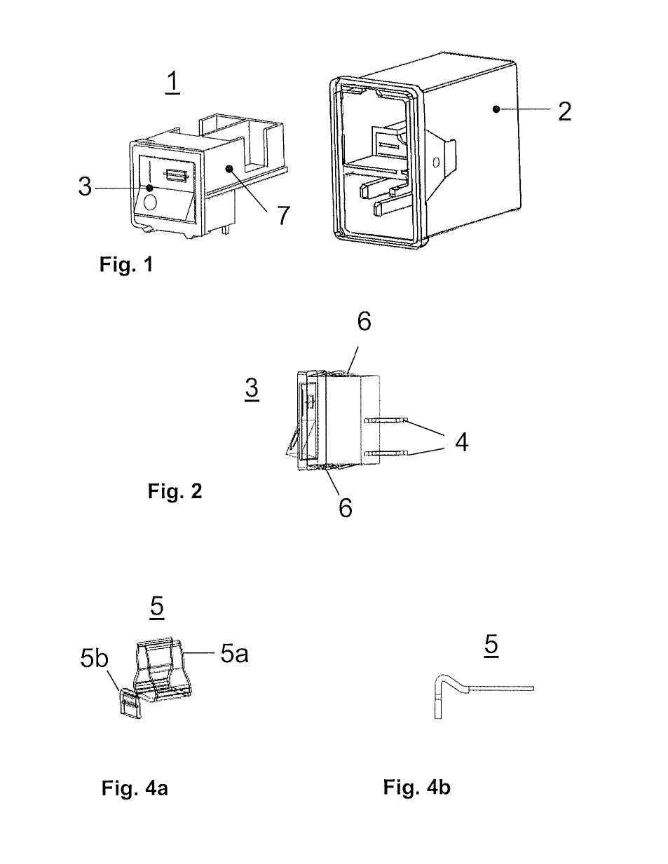

FIG. 1 shows a general view of the inventive removable rocker switch unit 1 with a switch body lodging electrical components 9. The rocker switch unit 1, which can be plugged into an EMC IEC inlet filter 2 or any other power entry module. On top of the rocker switch unit 1 is provided a switch or rocker switch having two positions, pivotably switching between one ON-position and one OFF-position. As switch in the present invention it is possible to take a rocker switch 7, an Auto or remote-off rocker switch or simply a current breaker without parting from the inventive idea.

As seen in the FIG. 2 the switch unit 1 consists out of a rocker switch 3 having on his back side four vertically and horizontally aligned connection elements 4, two of which vertically aligned connection elements 4 can be connected by switching the rocker switch 3 in the ON-position and disconnecting the same by switching the rocker switch in the OFF-position. The number of connection elements 4 is however given by way of example and can be vary according to the rocker switch unit 1. Two clipping element 6 are provided on each side of the rocker switch 3, with which the rocker switch 3 can be fixed to a housing 7. Again, the number of clipping element 6 is given by way of example and can be vary especially according to the size of rocker switch unit 1.

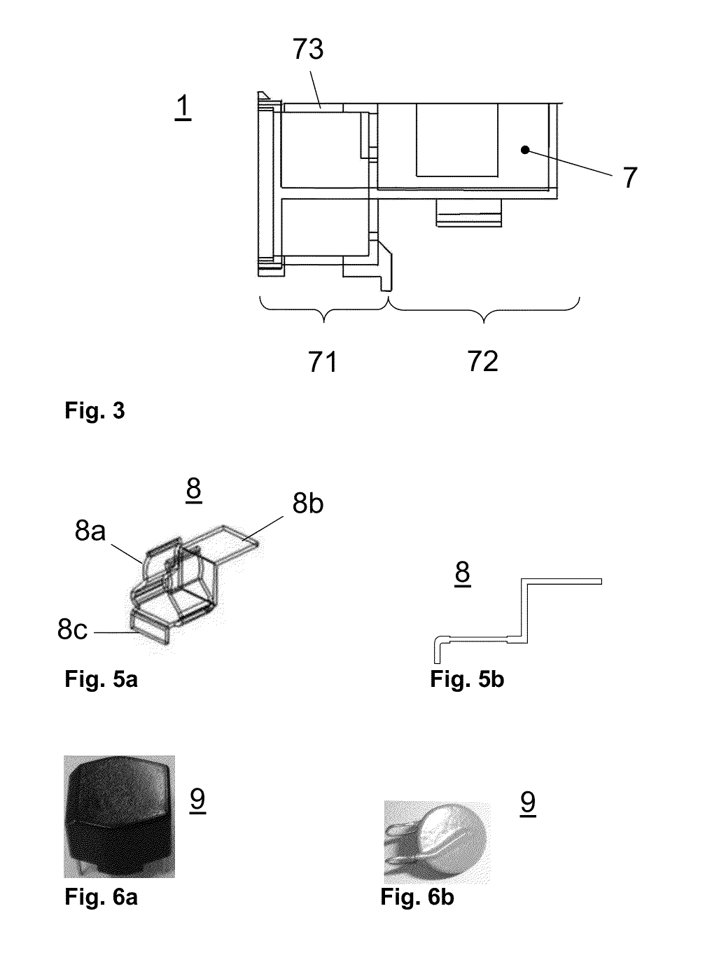

The housing 7 of rocker switch unit 1 is shown in FIG. 3. According to the invention the housing 7 consists of a single moulded piece, although it could possibly consists of different parts. It has a first end 71 to be connected to the rocker switch 3 and a second end 72, in which in an upper part two chambers for a fuse 9, a current limiter 9 and/or a varistor 9 are provided. For security reasons both chambers are separated from each other by an internal wall. According to the invention in the chamber can be enter one of the following elements: a fuse 9, a current limiter 9 (FIG. 6a) or said fuse 9 (FIG. 6b) and said current limiter 9 in a series connection. In still another possibility a varistor 9 could be connected between connecting elements 5, 8, thereby connecting one phases with the other phase. This varistor 9 could be assembled alone or in addition one or a plurality of said above mentioned elements. If there is only one varistor the connection elements 5, 8 are coupled directly together (e.g. by a wire, directly, by a dummy fuse, etc).

Additionally, the chambers have two lateral apertures for controlling the state of the electrical elements 9 and for better assembling/removing said elements 9. Below the apertures on the outside of the housing 7 lateral guiding rails are provided to guide the unit 1 in the inlet filter 2. Corresponding rails are provided in the inlet filter 2 or the apparatus, where the unit 1 will be entered. Since the chamber has only the size of half of the switcher 3, which is sufficient to house the fuse 9 or the other connection elements, in the bottom part of the second end 72 a step to the first end 71 is created. Apertures 73 in the first end 71 correspond to the clipping element 6 so the first end 71 of the housing 7 can removably fixed around and to the switch 3. In the mentioned step of the housing 7 slits are provided for accommodating the lower connection elements 4 of the switch 3 so to provide external contacts of the entire unit 1. Assembly of the parts of the unit 1 including connecting elements 5, 8, the housing 7 and switch 3 can thus easy be done. The housing 7 has on the front end of the first end protrusions for fastening the unit 1 to any apparatus.

The FIGS. 4a, b illustrate in detail first different connection elements 5. For the sake of assembling fuses connecting elements 5 (here fuse holders) are connected to the upper connecting elements 4. The fuse holders 5 consists of a holder 5a for clamping the fuses 9 and with slit connecting ends 5b shown in detail in FIG. 4a. After final assembly, the fuse holders 5 are fixed in a way that the holder 5a is within the housing 7 and connecting ends 5b are external of the inner wall of the housing 7. In this way not only the fuse holders 5 are directly fixed after assembly, but have also a good contact to the connecting elements 4. To fasten a current limiter 9 and/a varistor 9 FIG. 4b illustrates another embodiment of the connecting elements 5. The current limiter and/or the varistor 9 can be fixed to the connecting elements in a known manner such as soldering.

The FIGS. 5a, b illustrate in detail second connection elements 8. In the chambers are provided for example second fuse holders 8, which can be seen in detail in FIG. 5a. The fuse holder 8 comprise the holder 8a itself, the connection elements 8b, and ends 8c. In place within the chamber, the connection elements 8b are provided in slits in the second end of the chambers of the housing 7 to provide external contacts. In the bottom of the house slits are provided to accommodate and fix the ends 8c of the fuse holder 8. To fasten a current limiter 9 and/a varistor 9 FIG. 5b illustrates another embodiment of the connecting elements 8. The current limiter and/or the varistor 9 can be fixed to the connecting elements in known manner such as soldering.

The housing 7 consists of a single piece in which all part of the unit 1 can easily inserted or removed. The size of the unit 1 corresponds essentially to the size of the switch 3 itself, which representation a great advantage of the unit 1. Due to flexibility of the fuse connectors 5, 8, a fuse 9 can easily be removed or replaced. The assembled unit 1 is shown in FIG. 6.

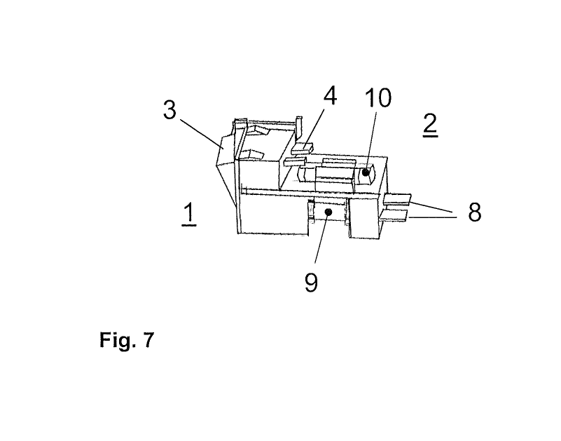

FIG. 7 illustrates a back side view of the inventive rocker switch unit 1. As seen in this embodiment a spare fuse 10 can be lodged on the bottom of the second part below the chambers and held by two lateral clipping elements. The entry unit has a recess for accommodating the spare fuse 10 (see FIG. 1).

The advantages of the inventive unit 1 is that from the housing surrounding the rocker switch 3 such that the rocker switch 3 gives essentially the size of the housing and the entire unit 1. From the outer side during normal operation the electrical elements 9 cannot be seen. An user needs not care about these elements 9. However, the unit 1 can be pulled of from an apparatus easily to change the fuse or even the entire unit 1, if necessary. This can be described in a manual of the apparatus. The rocker switch unit 1 as discloses herein can be used in any apparatus, in a network filter, as IEC entry plug or any power entry module.

### REFERENCE NUMBERS

1 Rocker switch unit
2 EMC IEC inlet filter
3 Rocker switch
4 Connecting element
5 Connecting element
5a Holder
5b Slit connection ends
6 Clipping element
7 Housing
71 First end of housing 7
72 Second end of housing 7
73 Aperture in Housing 7
8 Connection element
8a Holder
8b Connection elements
8c End
9 Fuse, varistor and/or current limiter
10 Spare fuse

1. A removable rocker switch unit comprising
a housing having a first end and a second end;
a rocker switch having an ON- and an OFF-position removably fixed to the first end of the housing, said rocker switch having two pairs of connector elements on the back side for connecting the rocker switch unit with external elements, wherein one pair of vertically aligned connector elements can be connected by switching the rocker switch to the ON-position;
said second end of said housing having a height smaller than the heights of the first end and providing two chambers, each chamber for each phase of said rocker switch comprising a first connection element connected to one connector element of said rocker switch and a second connection element for the connection of an external element;
said first and a second connection elements in each chamber arranged to be connected by a fuse, a current limiter or both in a series connection and/or by a varistor between connecting elements of said two different phases;
said first end of said housing below said chamber being closed by a wall, said wall providing slits for said connector elements protruding from the unit.

2. The removable rocker switch unit of claim 1, wherein said rocker switch is a rocker switch, an auto or remote-off rocker switch or a current breaker.

3. The removable rocker switch unit of claim 1, wherein a spare fuse is removably fixed on the bottom of the second part below said chamber.

4. The removable rocker switch unit of claim 1, wherein a fuse is held by a first and a second fuse holder as connection element.

5. The removable rocker switch unit of claim 4, wherein said second fuse holders consists of a holder (8a), a connection element (8b) and an end (8c), said connection element (8b) protruding through a slit of an second end of chamber opposite to the rocker switch for connecting the rocker switch unit with said external element, said end being fixed to the bottom of said chamber.

6. The removable rocker switch unit of claim 1, wherein said rocker switch has clipping elements for removable fixing said switch to said housing and wherein corresponding apertures are provided in said in housing.

7. The removable rocker switch unit of claim 1, wherein said chamber has lateral apertures.

8. The removable rocker switch unit of claim 1, wherein on the outside of the housing lateral guiding rails are provided.

9. The removable rocker switch unit of claim 1, wherein the housing has on the front end of the first end protrusions for fastening the unit to an apparatus.

10. The removable rocker switch unit of claim 1, wherein housing consists of a single piece.

11. The removable rocker switch unit of claim 1, wherein the housing surrounds the rocker switch such that the rocker switch gives essentially the size of the housing.

12. A use of the removable rocker switch unit of claim 1, whereby the removable rocker switch unit is removably inserted into an apparatus, in a network filter or as IEC entry plug.

13. An apparatus, network filter or IEC entry plug comprising an aperture for removably inserting the removable rocker switch unit of claim 1.
